(19) United States
(12) Patent Application Publication
(10) Pub. No.: US 2007/0108353 A1
(43) Pub. Date: May 17, 2007

(54) Adjustable vent pipe support

(76) Inventors: Marc E. Bikowsky, Hamilton, NY (US); Douglas C. Bikowsky, Hamilton, NY (US)

Correspondence Address: DAVID GIGLIO, ESQ., 231 ELIZABETH STREET, UTICA, NY, 13501, US

(21) Appl. No.: 11/274,911

(22) Filed: Nov. 16, 2005

(51) Int. Cl. F16L 3/24

(52) U.S. Cl. 248/71; 248/72; 248/74.1

(57) ABSTRACT

There is provided an adjustable vent pipe support which is secured to a ceiling joist. The vent pipe support is height adjusted to provide a proper pitch for a vent pipe. An upper support member singularly supports one or more sized vent pipes. A lower member includes openings that allow the vent pipe support to be fastened to the ceiling joist. A transverse member is superposed over the ceiling joist for additional support. Spacers are provided between the transverse member and the ceiling joist to provide height adjustment. The upper pipe support member includes various radii to accommodate various sized vent pipes.

### FIELD OF THE INVENTION

The present invention relates generally to the field of home construction and, more particularly to an apparatus which aids the home builder in installing vent pipes.

### BACKGROUND OF THE INVENTION

When constructing a house, it is necessary to provide for venting of noxious gases, such as from a sewer or a furnace. Typically, a vent pipe is vertically installed through a wall to the attic, and then laterally over the ceiling or floor joists in the attic to a point, at which the vent pipe becomes vertical once again as it passes through the roof.

It is important that there be a slight rise in the pitch of the vent pipe during its lateral run so that the noxious gases do not form pockets in the vent pipe. Installers typically cut small pieces of board and wedge them into between the vent pipe and the top surface of the ceiling or floor joist to provide the proper pitch.

Cutting boards is time consuming as it involves the installer finding and old board, setting the board on a horse and then cutting small pieces of the board. Often times different sized board widths are required to pitch the pipe. This process is time consuming.

Another problem with this process is that the boards often become loose and vibrations in the house cause them to fall out of place.

### OBJECTS AND SUMMARY OF THE INVENTION

It is an object of the present invention to improve the art of home construction.

It is another object of the present invention to improve the method and apparatus used to install vent pipes.

It is yet another object of the present invention to provide a pipe support that is quickly adjustable for height placement of a vent pipe over a ceiling or floor joist.

It is still another object of the present invention to provide an adjustable pipe support that prevents lateral movement of various sized vent pipes.

It is still another object of the present invention to provide an adjustable pipe support that prevents both lateral and longitudinal movement of various sized vent pipes.

These and other objects are provided in accordance with the present invention in which there is provided an adjustable vent pipe support which supports and provides proper pitching of a vent pipe over a ceiling joist. The adjustable vent pipe support includes a pipe support member which supports a vent pipe therein. Openings provided in a lower securing member allow the adjustable vent pipe support to be secured to the ceiling joist via screws or nails. Thus, the pipe support member is adjusted for height simply by determining an appropriate position in which to install the screw or nail.

A transverse member disposed between the pipe support member and the lower securing member is superposed over the top surface of the ceiling joist. Thus, the transverse member provides additional weight support. A spacer or a number of spacers are installed between the transverse member and the top surface of the ceiling joist to provide height adjustment.

A pair of opposing lower leg members installed on the ends of the transverse member provide additional support to prevent the pipe from rotating the vent support in a longitudinal direction relative to the pipe.

The pipe support member includes a lower arcuate surface which has a first radius. An interrupted arcuate surface having a larger second radius is eccentrically superposed over the lower arcuate surface. Thus, a larger diameter pipe sits on the interrupted arcuate surface, while a smaller diameter pipe slides through the interrupted portion and sites on the lower arcuate surface.

### BRIEF DESCRIPTION OF THE DRAWINGS

The present invention will be understood and appreciated more fully from the following detailed description taken in conjunction with the drawings in which:

FIG. 1 is a front perspective view of an adjustable vent pipe support of the present invention;

FIG. 2 is a side elevation view of the adjustable vent pipe support of FIG. 1 in use with a ceiling joist and a vent pipe;

FIG. 3 is a front elevation view of a pair of adjustable vent pipe supports of FIG. 1 as installed on a set of ceiling joists;

FIG. 4 is a side elevation view of an alternate embodiment of an adjustable vent pipe support in use with a spacer and a ceiling joist;

FIG. 5 is a side elevation view of another alternative embodiment of a pair of adjustable vent pipe supports in use with a pair of ceiling joists; and

FIG. 6 is a front perspective view of yet another alternate embodiment of an upper pipe support member of the adjustable vent pipe support of FIG. 1.

### DETAILED DESCRIPTION OF THE PRESENT INVENTION

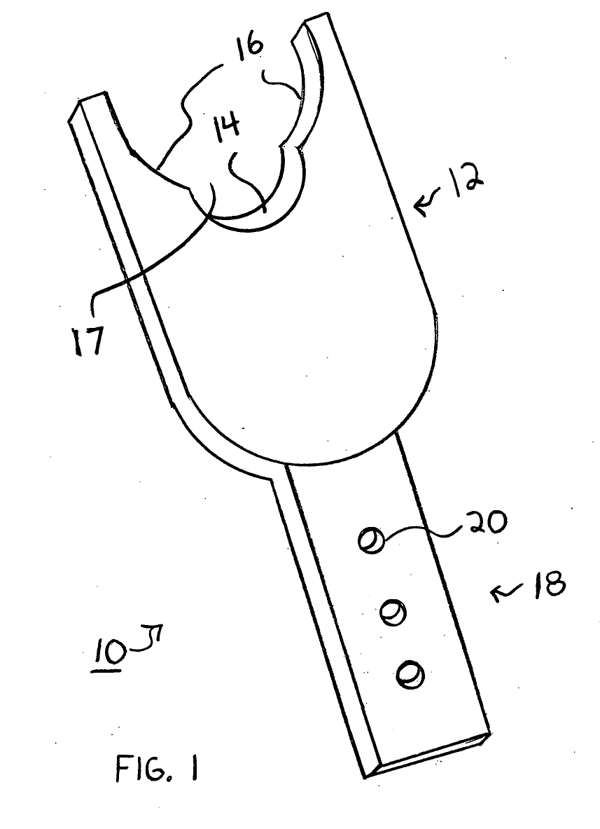

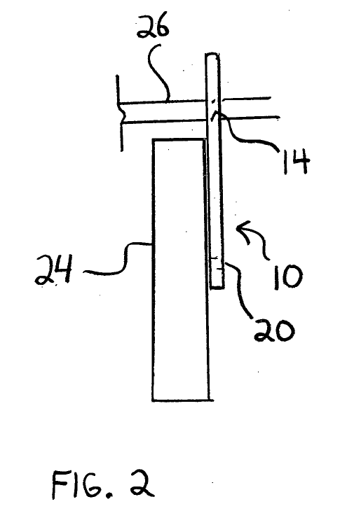

The present invention shall now be described in accordance with the FIGS. An adjustable vent pipe support 10, depicted in FIG. 1, includes an upper pipe support member 12. The upper pipe support member 12 includes an arcuate surface 14 which has a one inch radius that supports a two inch outside diameter vent pipe 26, shown in FIG. 2. An interrupted arcuate surface 16 having a one and one quarter inch radius, for supporting a two and one half inch outside diameter vent pipe, is eccentrically superposed above the one inch radius arcuate surface 14 in the upper pipe support member 12.

A two and one half inch outside diameter vent pipe rests on the interrupted arcuate surface 16, whilst a two inch outside diameter pipe 26 slides through the interrupted portion 17 of the interrupted arcuate surface 16 and fits comfortably onto the one inch radius arcuate surface 14. Thus, the upper pipe support member 12 comfortably supports two different sized vent pipes so that there is no lateral sway of the vent pipes.

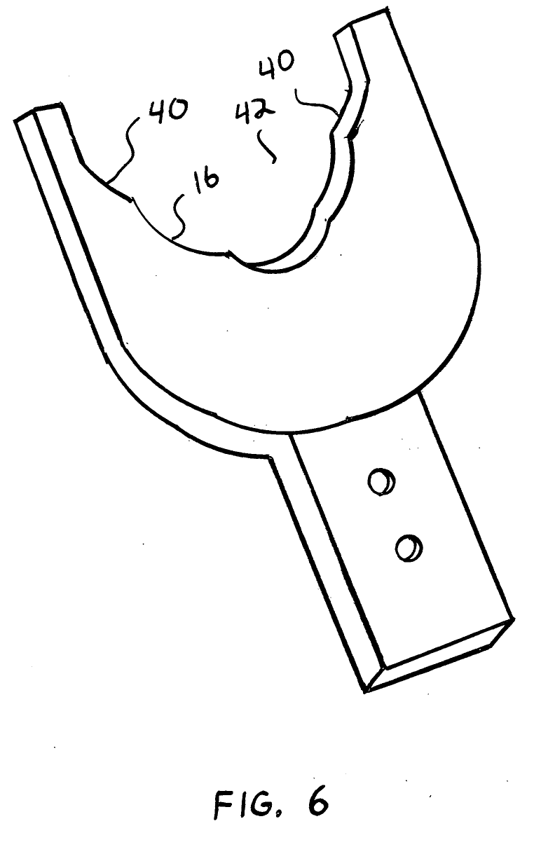

It should also be obvious that the upper pipe support member 12 may include only one size to accommodate only one sized pipe or smaller. Further, the upper pipe support member 12 can include a number of interrupted arcuate surfaces so that various sizes of vent pipes are accommodated. Looking at FIG. 6, a second interrupted arcuate surface 40 accommodates a three and one half inch outside diameter vent pipe, while allowing smaller diameter vent pipes to slide through the interrupted segment 42.

The vent pipe support 10 of the present invention allows the vent pipe to be properly pitched so that unwanted gases pass upward through the pipe 26 and out of the house. Since most vent pipes 26 have either a three inch or four inch outer diameter, both of these diameters are accommodated by the upper pipe support member 12.

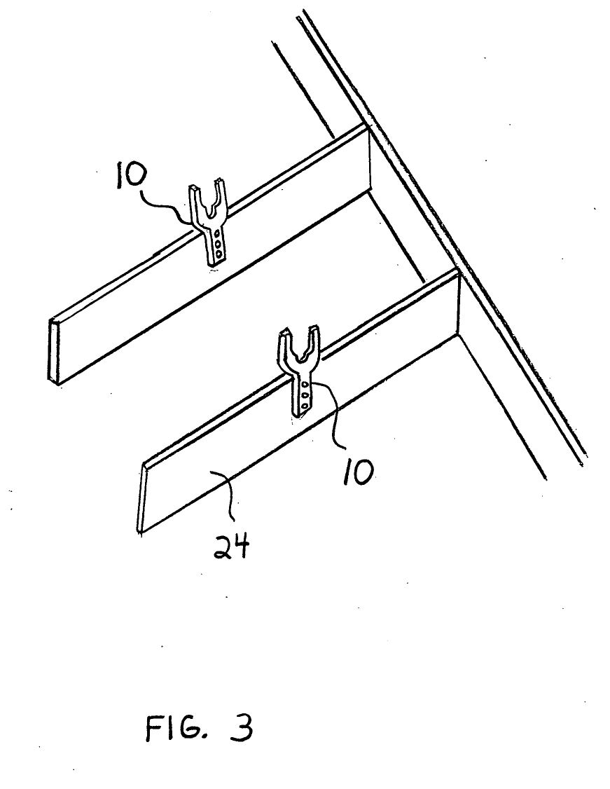

The vent pipe support 10 is attached to one or more ceiling joists 24 at such varying heights to keep the proper pitch in the vent pipe 26, depicted in FIG. 3. A securing member 18 extends from the pipe support member 12 and includes one or more openings 20 through which a fastener such as a threaded screw 36 or nail (not shown) is installed into the ceiling joist 24. As such, it is easy to adjust the height of the upper pipe support member 12 and, thus, control the pitch.

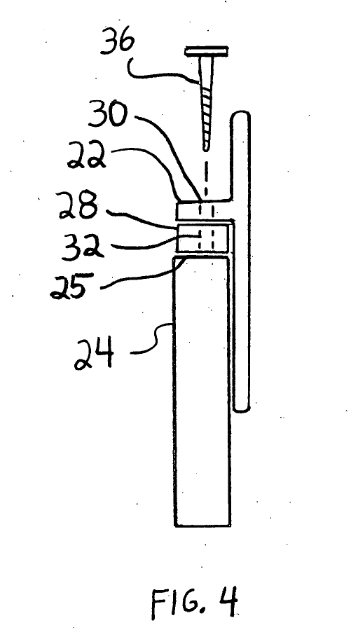

A transverse member 22 disposed between the upper pipe support member 12 and the securing member 18, depicted in FIG. 4, provides additional structural integrity to the vent pipe support 10 when the weight of the pipe 26 is provided onto the upper pipe support member 12. The transverse member 22 fits over a top surface 25 of the ceiling joist 24 and supports the weight of the vent pipe 26 so that such weight is not transferred to the threaded screw 36.

The height of the vent pipe support 10 is adjusted when in conjunction with the transverse member 22 by either providing varying height upper pipe support members 12 or by providing a spacer 28 which fits between the transverse member 22 and the top surface 25 of the ceiling joist 24. The height of the vent pipe support 10 is now adjusted by adding or removing spacers 28.

To prevent slipping of the spacer 28 or the transverse member 22 openings 30 and 32 are provided there through so that the screw 36 is installed through both openings 30, 32 and into the top surface 25 of the ceiling joist 24.

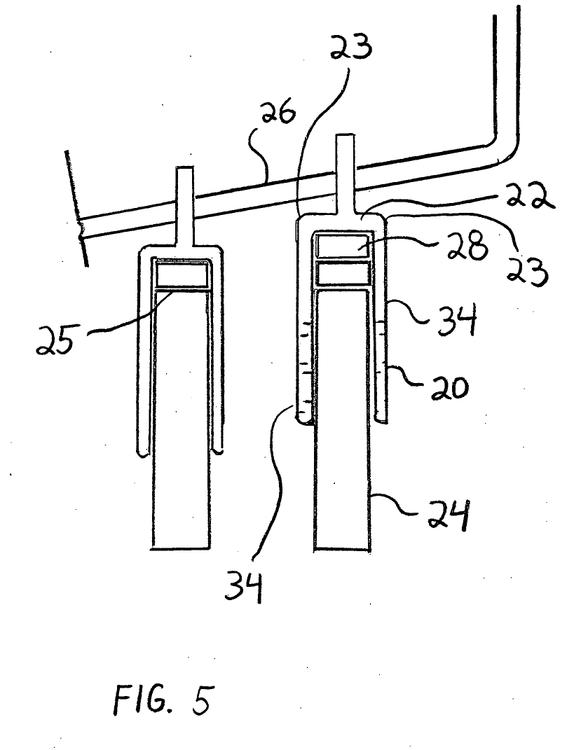

Opposing leg members 34 disposed off of each end 23 of the transverse member 22, depicted in FIG. 5, provide additional support which prevents longitudinal movement of the vent pipe 26. Once again spacers 28 allow for height adjustment of the vent pipe support 10.

Any of the embodiments of the vent pipe support 10 described herein are made from any suitable material, but preferably a plastic or polycarbonate type material. The vent pipe support 10 is one piece injected molded as are the associated spacers 28.

Various changes and modifications, other than those described above in the preferred embodiment of the invention described herein will be apparent to those skilled in the art. While the invention has been described with respect to certain preferred embodiments and exemplifications, it is not intended to. limit the scope of the invention thereby, but solely by the claims appended hereto.

What is claimed is:

1. An adjustable vent pipe support apparatus which supports and pitches a vent pipe over a ceiling joist, said apparatus comprising:
a pipe support member;
securing means extending from said pipe support member for securing said pipe support apparatus to said ceiling joist; and
height adjustment means for adjusting the height of said pipe support member over a top surface of said ceiling joist.

2. The vent pipe support apparatus of claim 1, wherein said pipe support member includes at least one arcuate surface.

3. The vent pipe support apparatus of claim 2, wherein said pipe support member includes a continuous arcuate surface having a first radius and a first interrupted arcuate surface eccentrically superposed over said continuous arcuate surface, said first interrupted arcuate surface having a second radius wherein said second radius is greater than said first radius.

4. The vent pipe support apparatus of claim 3 wherein said pipe support member further includes a second interrupted arcuate surface eccentrically superposed over said first interrupted arcuate surface, wherein said second interrupted arcuate surface includes a third radius that is greater than said second radius of said first interrupted arcuate surface.

5. The vent pipe support apparatus of claim 1, wherein said height adjustment means includes at least one lower member extending from said pipe support member, said at least one lower member further including at least one opening disposed there through for accommodating a fastener, said fastener being selected from a group consisting essentially of a threaded screw and a nail.

6. The vent pipe support apparatus of claim 1, wherein said height adjustment means further includes a transverse member disposed from a bottom portion of said pipe support member, and further including at least one lower member disposed from said transverse member.

7. The vent pipe support apparatus of claim 6, further including at least one spacer which fits between said transverse member and the top surface of the ceiling joist.

8. The vent pipe support apparatus of claim 7, wherein said at least one lower member includes a pair of opposing leg members interconnected by said transverse member, wherein said transverse member is aligned over the top surface of the ceiling joist.

9. The vent pipe support apparatus of claim 8, wherein said transverse member includes a dimension that is approximately the same as a width dimension of said ceiling joist.

10. The vent pipe support apparatus of claim 9, wherein at least one of said opposing leg member includes at least one opening there through.

11. The vent pipe support apparatus of claim 8, further including at least one spacer which fits between said transverse member and the top surface of the ceiling joist.

12. The vent pipe support apparatus of claim 6, wherein said transverse member further includes at least one opening there through.

13. The vent pipe support apparatus of claims 7 and 11, wherein said at least one spacer further includes at least one opening there through.
